(19) United States
(12) Patent Application Publication
(10) Pub. No.: US 2024/0292217 A1
(43) Pub. Date: Aug. 29, 2024

(54) Methods and Devices for Automatic Remote Authentication

(71) Applicant: Google LLC, Mountain View, CA (US)

(72) Inventors: Dongeek Shin, Santa Clara, CA (US); Anupam Pathak, San Carlos, CA (US)

(21) Appl. No.: 18/692,411

(22) PCT Filed: Oct. 7, 2021
(86) PCT No.: PCT/US2021/053989

§ 371 Date: Mar. 15, 2024

(51) Int. Cl. H04W 12/06; H04W 12/61; H04W 12/63

(52) U.S. Cl. CPC H04W 12/06; H04W 12/61; H04W 12/63

(57) ABSTRACT

A computer-implemented authentication method comprises broadcasting, by a first device, an ultrawideband (UWB) message. The first device receives one or more UWB responses to the UWB message from one or more UWB equipped devices and determines respective distances to the one or more UWB equipped devices based on timing information associated with the UWB message and the one or more UWB responses. The method further comprises determining one or more of the UWB equipped devices having a respective distance to the first device that is within a threshold radius of the first device to be authenticatable devices, and communicating, by the first device, authentication information to one or more of the authenticatable devices to authenticate a user of the first device on the one or more authenticatable devices.

### BACKGROUND

### Field

This application generally relates to authentication techniques to authenticate a user on a computing system. In particular, this application describes examples of methods and devices that facilitate automatic remote authentication of a user on a computing system.

### Description of Related Art

Many individuals use an array of computing devices on any given day, such as multiple personal computers, workstations, tablets, etc. Authentication of these computing devices typically involves bringing the computing device out of a standby state (e.g., by moving a mouse, pressing a key, etc.) and then entering a username and password associated with a user of the computing device. This process can be cumbersome. For example, the computing device may log the user out after a short period of inactivity, thus requiring the user to re-log on to the computing device. The user may forget the username and password for a particular computing device, thus necessitating multiple log-on attempts. In some instances, the user may be locked out of the computing device for an extended period of time, or permanently, after making too many unsuccessful log-on attempts.

### SUMMARY

In a first aspect, a computer-implemented authentication method comprises broadcasting, by a first device, an ultrawideband (UWB) message. The first device receives one or more UWB responses to the UWB message from one or more UWB equipped devices and determines respective distances to the one or more UWB equipped devices based on timing information associated with the UWB message and the one or more UWB responses. The method further comprises determining one or more of the UWB equipped devices having respective distances to the first device that are within a threshold radius of the first device to be authenticatable devices, and communicating, by the first device, authentication information to one or more of the authenticatable devices to authenticate a user of the first device on the one or more authenticatable devices.

In a second aspect, a computing device that facilitates remote authentication includes a memory and a processor and the memory stores instruction code. The processor is in communication with the memory. The instruction code is executable by the processor to cause the computing device to perform operations that include broadcasting, by the computing device, an ultrawideband (UWB) message. The computing device receives one or more UWB responses to the UWB message from one or more UWB equipped devices and determines respective distances to the one or more UWB equipped devices based on timing information associated with the UWB message and the one or more UWB responses. The operations further comprise determining one or more of the UWB equipped devices having respective distances to the computing device that are within a threshold radius of the computing device to be authenticatable devices, and communicating, by the computing device, authentication information to one or more of the authenticatable devices to authenticate a user of the computing device on the one or more authenticatable devices.

In a third aspect, a non-transitory computer-readable medium having stored thereon instruction code that facilitates remote authentication is provided. When the instruction code is executed by a processor of a computing device, the computing device performs operations that include broadcasting, by the computing device, an ultrawideband (UWB) message. The computing device receives one or more UWB responses to the UWB message from one or more UWB equipped devices and determines respective distances to the one or more UWB equipped devices based on timing information associated with the UWB message and the one or more UWB responses. The operations further comprise determining one or more of the UWB equipped devices having respective distances to the computing device that are within a threshold radius of the computing device to be authenticatable devices, and communicating, by the computing device, authentication information to one or more of the authenticatable devices to authenticate a user of the computing device on the one or more authenticatable devices.

In a fourth aspect, a computing device that facilitates remote authentication is provided. The computing device comprises means for broadcasting an ultrawideband (UWB) message. The computing device comprises means for receiving one or more UWB responses to the UWB message from one or more UWB equipped devices and for determining respective distances to the one or more UWB equipped devices based on timing information associated with the UWB message and the one or more UWB responses. The computing device further comprises means for determining one or more of the UWB equipped devices having respective distances to the computing device that are within a threshold radius of the computing device to be authenticatable devices, and for communicating authentication information to one or more of the authenticatable devices to authenticate a user of the computing device on the one or more authenticatable devices.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an environment that includes a carried device and a group of authenticatable devices, in accordance with example embodiments.

FIG. 2 illustrates information communicated between a carried device and an authenticatable device, in accordance with example embodiments.

FIG. 3 illustrates a block diagram of a carried device, in accordance with example embodiments.

FIG. 4A illustrates a graphical user interface (GUI) that can be displayed on a carried device, in accordance with example embodiments.

FIG. 4B illustrates another GUI that can be displayed on a carried device, in accordance with example embodiments.

FIG. 5 illustrates a GUI that can be displayed on an authenticatable device, in accordance with example embodiments.

FIG. 6 illustrates operations performed by one or more devices described herein, in accordance with example embodiments.

FIG. 7 illustrates a computer system, in accordance with example embodiments.

### DETAILED DESCRIPTION

Various examples of systems, devices, and/or methods are described herein. Any embodiment, implementation, and/or feature described herein as being an example is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Moreover, terms such as “substantially” or “about” that may be used herein are meant that the recited characteristic, parameter, or value need not be achieved exactly, but that deviations or variations, including, for example, tolerances, measurement error, measurement accuracy limitations and other factors known to those skilled in the art, may occur in amounts that do not preclude the effect the characteristic was intended to provide.

As noted above, the authentication of multiple computing devices can be cumbersome. To lessen the burden, in some computing environments, the user can log on to a device that is being carried by the user (hereinafter a carried device). The carried device may be associated with a second device (hereinafter authenticatable device). The authenticatable device can receive an indication that the user is logged on to the carried device and automatically log the user on to the authenticatable device when the user begins to interact with the authenticatable device (e.g., by moving the mouse, pressing a key, etc.).

In some of these environments, this indication is communicated via a short-range communication protocol such as a Bluetooth® or WiFi protocol. These protocols may specify the performance of a received signal strength measurement. This measurement can, in some cases, facilitate determining, by a first device of the environment, that it is in proximity to a second device of the environment. For example, the first device can infer that the second device is nearby (e.g., within 20 m) when the received signal strength is relatively high.

Unfortunately, signals communicated via these protocols tend to be susceptible to multipath interference and, therefore, these protocols are not very well suited for providing accurate range measurements. This problem is especially prevalent in indoor settings such as office environments where there may be many walls and/or partitions. For example, a particular user may have a smartwatch and a workstation computer that cooperate to facilitate automatic logging on of the user, as described above. Even when the user is away from the workstation (e.g., in the washroom), the workstation may determine that the smartwatch is nearby and, therefore, automatically log the user on to the workstation. This could render the workstation susceptible to hacking.

Several example devices or carried devices that ameliorate these and other issues are described herein. These carried devices broadcast an ultrawideband (UWB) message and subsequently receive one or more UWB responses to the UWB message from one or more UWB equipped devices. The carried devices then determine respective distances to the one or more UWB equipped devices based on timing information associated with the UWB message and the one or more UWB responses. The carried devices then determine one or more of the UWB equipped devices having respective distances to the carried device that are within a threshold radius of the carried devices to be authenticatable devices and communicate authentication information to one or more of the authenticatable devices to authenticate a user of the carried device on the one or more authenticatable devices.

Some examples of the carried device correspond to a device that is being carried by a user, such as a mobile phone, a smartwatch, etc. Some examples of the authenticatable device correspond to a computing system that requires a user to log on to the computing system before being allowed to operate the computing system, such as a personal computer, tablet, etc.

Some examples of these devices utilize a UWB communication protocol that is promulgated by the FiRa Consortium. Some of these protocols specify several different packet configurations for communicating information between FiRa compliant devices. Some of the packet configurations include a session timestamp (STS) that can be used by devices to determine the amount of time required for a UWB signal to travel between devices. This, in turn, facilitates determining the range between the devices to within centimeters, which is a vast improvement over the techniques described above. Some of the packet configurations also include payload data for communicating information between devices.

Some examples of the devices communicate the authentication information via a communication protocol that is different from the UWB communication protocol, such as a Bluetooth® protocol, a WiFi based protocol, etc.

Some examples of the carried device communicate the authentication information to a particular authenticatable device that is closest in distance to the carried device. Some examples of the carried device determine their direction of travel relative to the authentication devices and communicate the authentication information to an authentication device that is both closest in distance and that is in the direction of travel of the carried device.

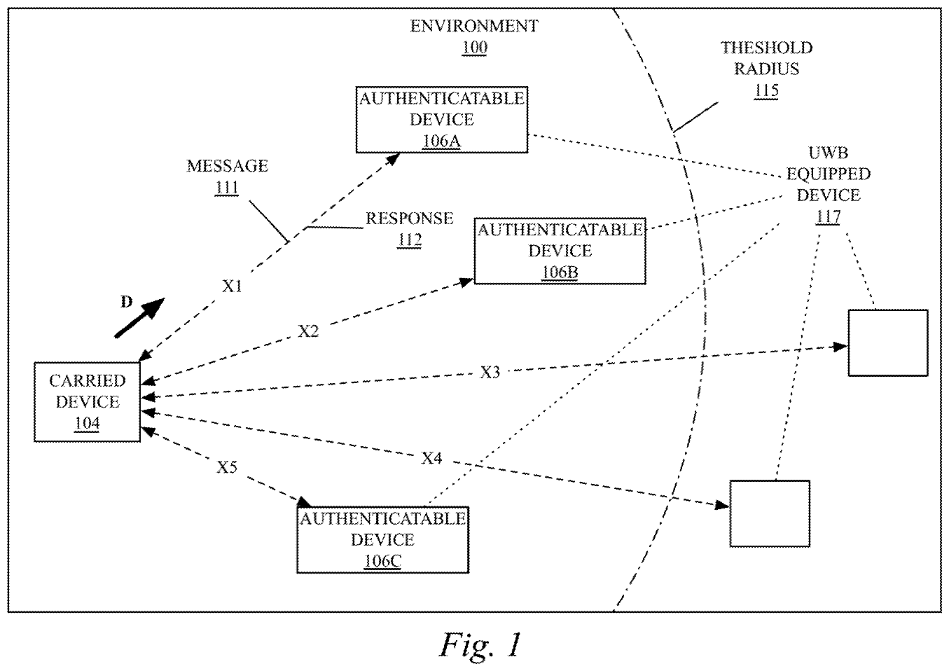

FIG. 1 illustrates an example of an environment 100 that includes a carried device 104 and a group of UWB equipped devices 117. Some of the UWB equipped devices 117 are authenticatable devices 106. As noted above, some examples of the carried device 104 correspond to mobile devices or wearable devices (e.g., mobile phone, smartwatch, etc.). Some examples of the UWB equipped devices 117, and in particular, the authenticatable devices 106 correspond to personal computers, tablets, other mobile devices, etc. The distances, X1-X5, between the carried device 104 and each UWB equipped device 117 can be different. In some examples, the distance between the carried device 104 and each of the UWB equipped devices 117 is relatively static. In other examples, the carried device 104 is moving in a particular direction (denoted as D in the figure) towards one or more of the UWB equipped devices 117.

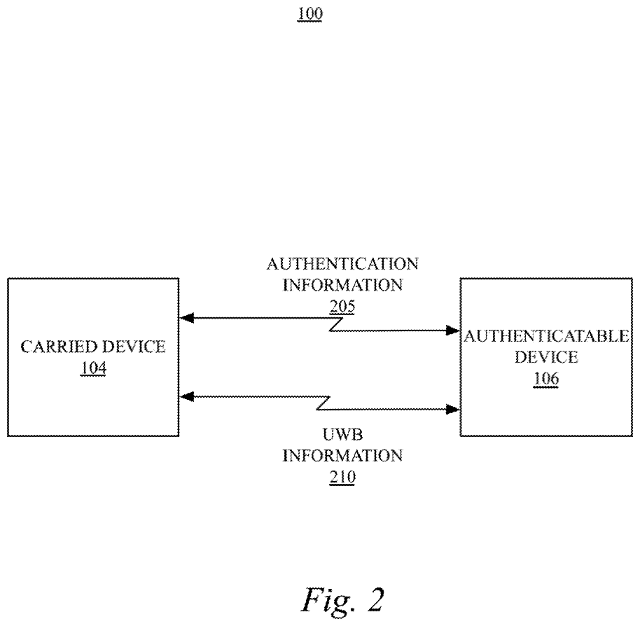

As described in further detail below, in operation, the carried device 104 is configured to broadcast an ultrawideband (UWB) message 111 and subsequently receive one or more UWB responses 112 to the UWB message 111 from one or more UWB equipped devices 117. The carried device 104 then determines respective distances, X1-X5, to the UWB equipped devices 117 based on timing information associated with the UWB message 111 and the UWB responses 112. The carried device 104 then determines one or more of the UWB equipped devices 117 having respective distances to the carried device 104 that are within a threshold radius 115 of the carried device 104 to be authenticatable devices 106 and communicates authentication information (FIG. 2, 205) to one or more of the authenticatable devices 106 to authenticate a user of the carried device 104 on the one or more authenticatable devices 106. As described in further detail below, examples of threshold radius 115 are predefined and/or learned based on user feedback.

FIG. 2 illustrates an example of information communicated between a carried device 104 and an authenticatable device 106 that can correspond to the carried device 104 and authenticatable devices 106 described above. The information includes authentication information 205 and UWB information 210. As described above, the authentication information 205 facilitates authenticating a user of the carried device 104 with the authenticatable device 106. The UWB information 210 facilitates determining the distance between the carried device 104 and the authenticatable device 106.

Some examples of the authentication information specify a username and a password associated with the user of the carried device 104. The username and password can correspond to a username and password that the user would otherwise use to, for example, log on to the authenticatable device 106 (e.g., the username and password that would be specified in an authentication window presented to the user of a computer).

Some examples of the authentication information 205 specify biometric information associated with the user of the carried device 104. Examples of biometric information include fingerprint information, facial feature information, etc.

It should be noted that with respect to embodiments that involve specifying usernames, biometric information, etc. and in the authentication information 205, a user may be provided with controls that allow the user to make an election as to both if and when systems, programs, or features described herein may enable collection of such user information. In addition, certain data may be treated in one or more ways before it is stored or used, so that personally identifiable information is removed. For example, a user's identity may be treated so that no personally identifiable information can be determined for the user. Thus, the user may have control over what information is collected about the user, how that information is used, and what information is provided to the user.

In some examples, after receiving the authentication information 205, the authenticatable device 106 is configured to authenticate the user without generating an indication that the user is authenticated. For instance, some examples of the authenticatable device 106 authenticate the user without waking up the display or terminating a screensaver application (e.g., the display remains black, the screen saver continues to run). In these examples, after authentication, when the user interacts with the authenticatable device 106 (e.g., by moving a mouse, pressing a key, touching a pad, etc.), the authenticatable device 106 displays an indication that the user is logged on to the authenticatable device 106 (e.g., the user's desktop is shown).

Some examples of the devices utilize a common bearer to communicate both the authentication information 205 and the UWB information 210. For instance, in some examples, the UWB information 210 and the authentication information 205 are communicated via a UWB protocol. In this regard, examples of the authentication information 205 are communicated as part of the payload data of a particular UWB packet configuration.

Some examples of the devices utilize different bearers to communicate the authentication information 205 and the UWB information 210. For instance, in some examples, the UWB information 210 is communicated via a UWB protocol and the authentication information 205 is communicated via a protocol such as Bluetooth® or a different protocol.

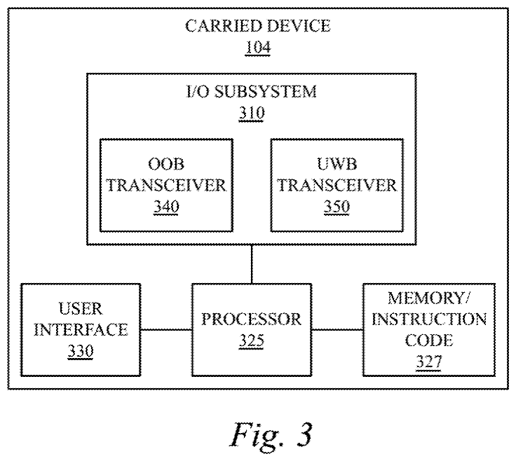

FIG. 3 illustrates a block diagram of a carried device 104, which corresponds to the carried device 104 described above. One or more of the aspects described with respect to the carried device 104 can be implemented by some examples of the authenticatable device 106. Some examples of the carried device 104 correspond to a mobile device, tablet, wearable device, personal computer, etc. The carried device 104 includes a memory 327, a processor 325, a user interface 330, and an input/output (I/O) subsystem 310.

The processor 325 is in communication with the memory 327. The processor 325 is configured to execute instruction code stored in the memory 327. The instruction code facilitates performing, by the carried device 104, various operations that are described below. In this regard, the instruction code may cause the processor 325 to control and coordinate various activities performed by the different subsystems of the carried device 104. Some examples of the processor 325 can correspond to a stand-alone computer system such as an ARM®, Intel®, AMD®, or PowerPC® based computer system or a different computer system and can include application-specific computer systems. The computer system can include an operating system, such as Android™, Windows®, Linux®, Unix V, or a different operating system.

Some examples of the user interface 330 include display circuitry. Examples of the display circuitry include a liquid crystal display (LCD), light-emitting diode display (LED) display, etc. The display may include a transparent capacitive touchpad that facilitates receiving user commands. In this regard, some examples of the display circuitry are configured to present a graphical user interface (GUI). Some examples of the GUI facilitate notifying a user of a carried device 104 that one or more authenticatable devices 106 are in proximity of the user (e.g., within 50 m). In some examples, the authenticatable devices 106 are configured beforehand to facilitate authentication from a carried device 104. Some examples of the GUI facilitate specifying one or more authenticatable devices 106 that should be authenticated automatically according to the example authentication techniques described herein.

Some examples of the I/O subsystem 310 include one or more input/output interfaces configured to facilitate communications with entities outside of the carried device 104. For instance, the I/O subsystem 310 may include wireless communication circuitry that implements an out-of-band (OOB) transceiver 340 configured to facilitate wireless communications with other devices. Examples of the OOB transceiver 340 facilitate communicating information over a cellular telephone network (e.g., 3G, 4G, and/or 5G network, etc.). Examples of the OOB transceiver 340 facilitate communications over a local network (e.g., WiFi networks, Zigbee® networks, etc.). Examples of the OOB transceiver 340 facilitate device-to-device communications such as Bluetooth® communications.

Some examples of the wireless communication circuitry implement a UWB transceiver 350 that facilitates communicating UWB information 210 with other similarly equipped devices (i.e., devices that include a similarly configured UWB transceiver). In some examples, the UWB information 210 is communicated in the 3.1 GHz to 10.6 GHz range and occupies a bandwidth of, e.g., between 475 MHz and 525 MHz. In some examples, the frequency and bandwidth conform to UWB transmission requirements promulgated by a regulating authority (e.g., the Federal Communications Commission).

In some examples, information communicated via the UWB transceiver 350 is encoded as a sequence of short pulses (e.g., 2-3 nS). The short pulses facilitate performing ranging operations such as determining the distance between the carried device 104 and an authenticatable device 106. In an example, the accuracy of the range can be determined within several centimeters.

In some examples, the wireless communication circuitry implements a pair of UWB transceivers 350. Respective antennas for the pair of UWB transceivers 350 may be spaced apart from one another (e.g., along an edge of the carried device 104). The pair of UWB transceivers 350 facilitate determining a pair of distances from the carried device 104 to one or more authenticatable devices 106, which, in turn, facilitates determining an orientation of the carried device 104 relative to the authenticatable devices 106.

In operation, the carried device 104 is configured to determine its distance from one or more authenticatable devices 106 via, for example, the UWB transceiver 350. For instance, an example of the carried device 104 communicates or broadcasts UWB information 210 via the UWB transceiver 350. One or more similarly equipped authenticatable devices 106 that are in the range of the carried device 104 (e.g., within 20 m) respond to the UWB broadcast and establish communications with the carried device 104.

After determining the distance from the authenticatable devices 106, some examples of the carried device 104 are configured to send authentication information 205 to one or more of the authenticatable devices that are within a predetermined authentication distance or radius 115 (e.g., 10 m). When multiple authenticatable devices 106 are within the authentication radius 115, some examples of the carried device 104 are configured to send the authentication information 205 to the closest authenticatable device 106. For instance, referring to FIG. 1, the distance to the first, second, and third authenticatable devices 106A, 106B, and 106C may be determined to be X1, X2, and X5, respectively, where X5 is the shortest distance. In this example, the carried device 104 may communicate the authentication information 205 to the third authenticatable device 106C because it is the closest authenticatable device 106.

Some examples of the carried device 104 are configured to determine the rate at which they approach one or more authenticatable devices 106. This, in turn, facilitates determining whether the carried device 104 is moving in a particular direction towards a particular authenticatable device 106. In this regard, some examples of the carried device 104 are configured to communicate authentication information 205 to an authenticatable device 106 that is both closest in distance to the carried device 104 and that is in the direction of travel of the carried device 104. For example, as shown in FIG. 1, the carried device 104 is moving in direction D generally towards the first and second authenticatable devices 106A and 106B and generally away from the third authenticatable device 106C. In this case, even though the carried device 104 is closer to the third authenticatable device 106C, the carried device 104 communicates the authentication information 205 to the first authenticatable device 106A because that authenticatable device is in the direction of travel and is the closest authenticatable device.

Some examples of the carried device 104 are configured to increase the threshold distance for authenticating an authenticatable device 106 in the direction of travel and to decrease the threshold distance in other directions. For instance, in an example, the threshold distance in the direction of travel is 10 m and the threshold distance in other directions is 2 m. In this case, an authenticatable device 106 in the direction of travel that is 9 m away can be authenticated whereas an authenticatable device 106 that is 5 m away but in a different direction is not authenticated.

Some examples of the carried device 104 are configured to communicate a de-authentication instruction to an authenticatable device 106 (e.g., send instructions to log a particular user out of the authenticatable device 106). For example, after authenticating the user on a particular authenticatable device 106, some examples of the carried device 104 determine that the distance from the authenticatable device 106 exceeds a second threshold or de-authentication distance and de-authenticate the user on the authenticatable device 106. The de-authentication distance may be greater than the authentication distance to provide a degree of hysteresis (e.g., to prevent spurious authentication and de-authentication of an authenticatable device 106). For example, the authentication distance may be 10 m, and the de-authentication distance may be 20 m. In some examples, the respective distances are the same.

Some examples of the carried device 104 only communicate the authentication information 205 if the user is authenticated with the carried device 104. For instance, if the carried device 104 is in the user's pocket, the user may not be authenticated with the carried device 104. In this case, the carried device 104 may not communicate the authentication information 205 as described above. The carried device 104 may authenticate after the user removes the carried device 104 from his pocket and logs on to the carried device 104.

Some examples of the carried device 104 only communicate the authentication information 205 if the carried device 104 is oriented in a direction towards the authenticatable device. For instance, if the carried device 104 is in the user's pocket, the carried device 104 may not be correctly oriented. In this case, the carried device 104 may not communicate the authentication information 205, as described above. The carried device 104 may authenticate after the user removes the carried device 104 from the pocket and orients the carried device 104 towards the authenticatable device 106.

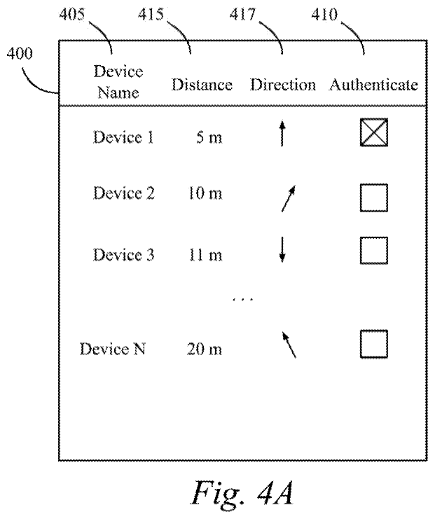

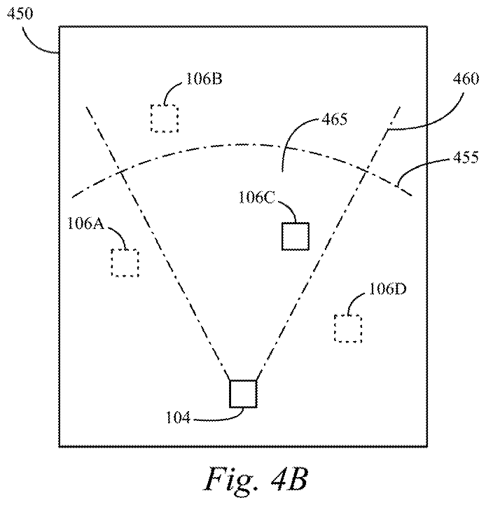

FIG. 4A illustrates an example of a GUI 400 that can be displayed on some examples of the carried device 104 described herein. The GUI 400 facilitates selecting one or more authenticatable devices 106 to authenticate. In some examples, the GUI 400 is automatically presented on the carried device 104 when the carried device 104 comes within the communication range of an authenticatable device 106. The GUI 400 includes a list of authenticatable device names 405 and corresponding authentication controls 410 that facilitate selecting one or more authenticatable devices 106 to authenticate. Some examples of the GUI 400 show a distance 415 between authenticatable devices 106 and the carried device 104. In some examples, the list is sorted by distance (e.g., the closest authenticatable device 106 is listed first, followed by the next closest authenticatable device 106). Some examples of the GUI 400 show direction indications 417 that indicate respective directions to the authenticatable devices 106. For instance, in the GUI, the direction indicator for the first listed item indicates that the authenticatable device 106 is in front of the user or that the user is walking directly towards the authenticatable device. The direction indicator for the second listed item indicates that the authenticatable device 106 is in front of and off to the right of the user or that the user is generally walking towards the authenticatable device 106. The direction indicator for the third listed item indicates that the authenticatable device 106 is behind the user or that the user is walking directly away from the authenticatable device.

In some examples, the authenticatable devices 106 in the list correspond to those authenticatable devices 106 that are within the communication range of the carried device 104 (e.g., within 20 m). In this regard, in some examples, the list is updated (e.g., authenticatable devices 106 are added and/or removed) as the carried device 104 approaches particular authenticatable devices 106 or travels away from particular authenticatable devices 106. In some examples, the distances 415 and the directions 417 are updated as the carried device 104 moves relative to the authenticatable devices 106. In some examples, the distances 415 and the directions 417 are determined according to the techniques described above.

FIG. 4B illustrates an example of another GUI 450 that can be displayed on some examples of the carried device 104 described herein. In some examples, the GUI 450 is automatically presented on the carried device 104 when the carried device 104 comes within the communication range of an authenticatable device 106. The GUI 450 provides the location of authenticatable devices 106 relative to the carried device 104. For instance, in an example, the carried device 104 is depicted in the bottom center of the GUI 450 and first, second, third, and fourth authenticatable devices (106A, 106B, 106C, and 106D) that are in front of the carried device 104 are depicted above the carried device 104. In some examples, the distances and the directions are determined according to the techniques described above.

Examples of the GUI 450 also depict a radius/distance indicator 455 and/or a field-of-view indicator 460. In operation, some examples of the carried device 104 are configured to communicate authentication information 205 to those authenticatable devices 106 that fall within a specified radius and/or specified field-of-view of the carried device 104. For example, the radius/distance indicator 455 and the field-of-view indicator 460 together define a cone-of-selection 465. Some examples of the carried device 104 are configured to communicate authentication information 205 to those authenticatable devices 106 located within the cone-of-selection 465. In some examples, the GUI 450 facilitates dragging the radius/distance indicator 455 and/or the field-of-view indicator 460 to adjust the cone-of-selection 465 accordingly.

In some examples, authenticatable devices 106 that can be authenticated are indicated differently than those that cannot be authenticated. For example, the first, second, and third authenticatable devices (106A, 106B, and 106D) are indicated with dashed lines to indicate that they cannot be authenticated, and the third authenticatable device 106C is indicated in solid lines to indicate otherwise. In some examples, the authenticatable devices 106 are indicated as such because they either fall within or outside of the cone-of-selection 465. In some examples, a particular authenticatable device 106 that falls within the cone-of-selection 465 may nevertheless be indicated as non-authenticatable because, for example, the authenticatable device 106 refuses remote authentication.

In some examples, the GUI 450 is updated as the carried device 104 is moved or rotated. For example, while viewing the GUI 450, the user of the carried device 104 may turn around, and the GUI 450 may update to show one or more authenticatable devices 106 that were previously behind the user.

In some examples, rather than automatically authenticating the authenticatable device 106, the GUI 450 facilitates the selection of an authenticatable device 106 to authenticate. For example, clicking on a particular authenticatable device 106 in the GUI 450 controls the carried device 104 to communicate authentication information 205 to the clicked authenticatable device 106.

Some examples of the carried device 104 are configured to learn or predict the parameters associated with the cone-of-selection 465. For instance, during a learning/training phase, the carried device 104 may specify the cone-of-selection 465 with default parameters. The user may then select authenticatable devices 106 to authenticate, in some cases selecting authenticatable devices outside of the cone-of-selection 465. After several iterations, the carried device 104 learns the distance of authenticatable devices 106 to which the user typically authenticates and increases or decreases the cone-of-selection 465 accordingly. After the learning/training phase, the carried device 104 can be configured to automatically authenticate similarly positioned authenticatable devices 106.

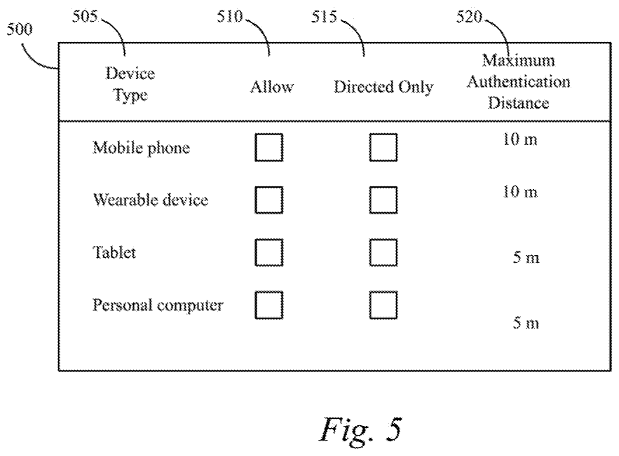

FIG. 5 illustrates an example of a GUI 500 that can be displayed on some examples of the authenticatable device 106. The GUI 500 includes a list of authentication rules associated with different types of carried devices 104. Examples of the rules specify a device type 505, an allow-control 510, and a directed-only control 515. The allow-control 510 facilitates specifying whether to allow remote authentication from the type of carried device 104 associated with the rule. The directed-only control 515 facilitates specifying whether to only allow remote authentication from a carried device 104 that is oriented/directed towards the authenticatable device 106 (e.g., heading directly or within a margin thereof, e.g., 10 degrees, towards the authenticatable device 106). Examples of the rules include a maximum authentication distance control 520 that facilitates specifying the maximum distance a particular type of device can be before automatic authentication is disallowed. Some examples may facilitate the specification of a de-authentication distance.

Some examples of the GUI 500 facilitate associating the rules with a particular user or a particular type of user (e.g., administrator, guest, etc.). For example, for an administrator of a large number of authenticatable devices 106 that are in close proximity with one another (e.g., in a student lab), the various distances may be set relatively small (e.g., 1 m) to avoid inadvertently authenticating devices 106 the administrator may not be interested in accessing.

It should be noted that one or more aspects and operations facilitated by the GUI of the authenticatable device 106 can be provided by the carried device 104. Likewise, one or more of the aspects and operations facilitated by the GUI of the carried device 104 can be provided by the authenticatable device 106.

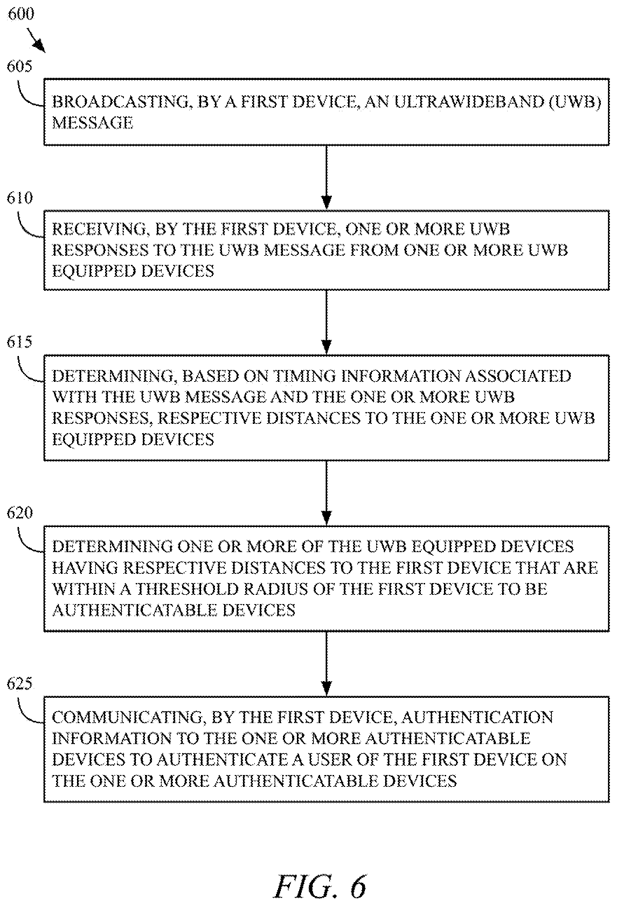

FIG. 6 illustrates an example of operations 600 performed by one or more of the devices described herein. The operations at block 605 involve broadcasting, by a first device 104, an ultrawideband (UWB) message.

The operations at block 610 involve receiving, by the first device 104, one or more UWB responses to the UWB message from one or more UWB equipped devices.

The operations at block 615 involve determining, based on timing information associated with the UWB message and the one or more UWB responses, respective distances to the one or more UWB equipped devices.

The operations at block 620 involve determining one or more of the UWB equipped devices having respective distances to the first device that are within a threshold radius of the first device to be authenticatable devices 106.

The operations at block 625 involve communicating, by the first device 104, authentication information to one or more of the authenticatable devices 106 to authenticate a user of the first device 104 on the one or more authenticatable devices 106.

In some examples of the operations, after authenticating the user on the one or more authenticatable devices 106, the operations involve determining, by the first device 104, that the respective distances from the one or more authenticatable devices 106 exceed a second threshold distance. Responsive to determining that the respective distances exceed the second threshold distance, the first device 104 communicates a de-authentication instruction to the one or more authenticatable devices 106 to de-authenticate the user on the one or more authenticatable devices 106.

In some examples of the operations, communicating the authentication information 205 to the one or more authenticatable devices 106 involves communicating the authentication information 205 via a communication protocol that is different from a UWB communication protocol.

In some examples of the operations, communicating the authentication information 205 via a communication protocol that is different from the UWB communication protocol involves communicating the authentication information 205 via one of: a Bluetooth® protocol, or a WiFi based protocol.

In some examples of the operations, communicating the authentication information 205 to the one or more authenticatable devices 106 involves communicating the authentication information 205 to a particular authenticatable device 106 of the one or more authenticatable devices 106 that is closest in distance to the first device 104.

Some examples of the operations involve determining the direction of travel of the first device 104. In these examples, communicating the authentication information 205 to the particular authenticatable device 106 that is closest in distance to the first device 104 involves communicating the authentication information 205 to a particular authenticatable device 106 of the one or more authenticatable devices 106 that is closest in distance to the first device 104 and that is in the direction of travel.

In some examples of the operations, determining the direction of travel of the first device 104 involves determining, by the first device 104, a rate at which first device 104 approaches one or more authenticatable devices 106.

In some examples of the operations, communicating, by the first device 104, the authentication information 205 to the one or more authenticatable devices 106 involves communicating authentication information 205 configured to cause the one or more authenticatable devices 106 to authenticate the user without generating an indication that the user is authenticated.

In some examples of the operations, the authentication information 205 specifies a username and a password associated with the user of the one or more authenticatable devices 106.

In some examples of the operations, communicating, by the first device 104, authentication information to the one or more of the authenticatable devices 106 comprises communicating, by a wearable device, authentication information to one or more personal computers to authenticate a user of the wearable device on the one or more personal computers.

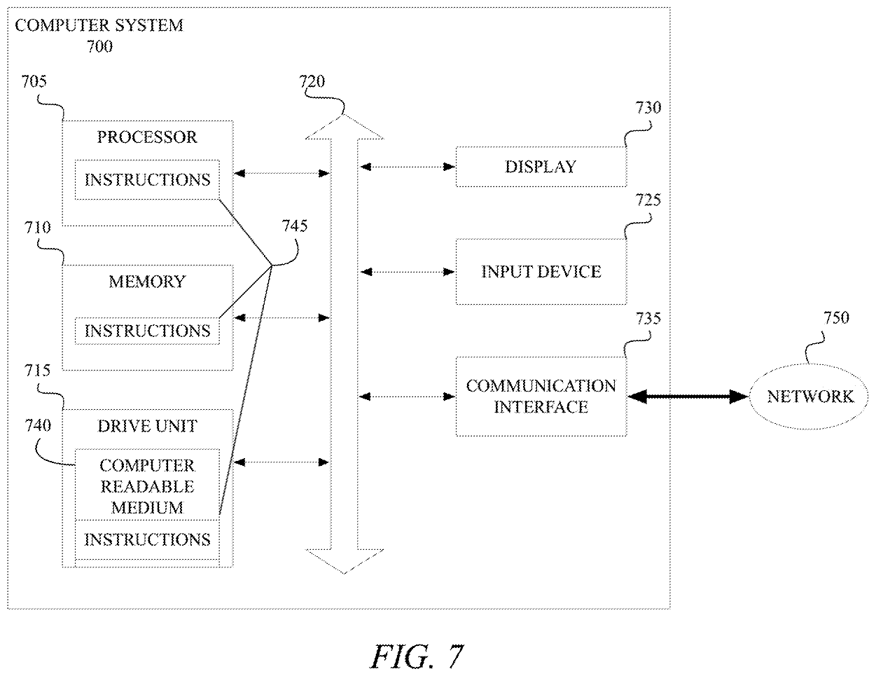

FIG. 7 illustrates an example of a computer system 700 that can form part of or implement any of the systems and/or devices described above. The computer system 700 can include a set of instructions 745 that the processor 705 can execute to cause the computer system 700 to perform any of the operations described above. An example of the computer system 700 can operate as a stand-alone device or can be connected, e.g., using a network, to other computer systems or peripheral devices.

In a networked example, the computer system 700 can operate in the capacity of a server or as a client computer in a server-client network environment, or as a peer computer system in a peer-to-peer (or distributed) environment. The computer system 700 can also be implemented as or incorporated into various devices, such as a personal computer or a mobile device, capable of executing instructions 745 (sequential or otherwise), causing a device to perform one or more actions. Further, each of the systems described can include a collection of subsystems that individually or jointly execute a set, or multiple sets, of instructions to perform one or more computer operations.

The computer system 700 can include one or more memory devices 710 communicatively coupled to a bus 720 for communicating information. In addition, code operable to cause the computer system to perform operations described above can be stored in the memory 710. The memory 710 can be random-access memory, read-only memory, programmable memory, hard disk drive, or any other type of memory or storage device.

The computer system 700 can include a display 730, such as a liquid crystal display (LCD), organic light emitting diode (OLED) display, or any other display suitable for conveying information. The display 730 can act as an interface for the user to see processing results produced by processor 705.

Additionally, the computer system 700 can include an input device 725, such as a keyboard or mouse or touchscreen, configured to allow a user to interact with components of system 700.

The computer system 700 can also include drive unit 715 (e.g., flash storage). The drive unit 715 can include a computer-readable medium 740 in which the instructions 745 can be stored. The instructions 745 can reside completely, or at least partially, within the memory 710 and/or within the processor 705 during execution by the computer system 700. The memory 710 and the processor 705 also can include computer-readable media, as discussed above.

The computer system 700 can include a communication interface 735 to support communications via a network 750. The network 750 can include wired networks, wireless networks, or combinations thereof. The communication interface 735 can enable communications via any number of wireless broadband communication standards, such as the Institute of Electrical and Electronics Engineering (IEEE) standards 802.11, 802.12, 802.16 (WiMAX), 802.20, cellular telephone standards, or other communication standards.

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation; and b) reproduction of a first language, code, or notation.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

1. A computer-implemented authentication method comprising:
broadcasting, by a first device, an ultrawideband (UWB) message;
receiving, by the first device, one or more UWB responses to the UWB message from one or more UWB equipped devices;
determining, based on timing information associated with the UWB message and the one or more UWB responses, respective distances to the one or more UWB equipped devices;
determining one or more of the UWB equipped devices having respective distances to the first device that are within a threshold radius of the first device to be authenticatable devices; and
communicating, by the first device, authentication information to one or more of the authenticatable devices to authenticate a user of the first device on the one or more authenticatable devices.

2. The method according to claim 1, the method further comprising:
after authenticating the user on the one or more authenticatable devices, determining, by the first device, that respective distances from the one or more authenticatable devices exceed a second threshold distance; and
responsive to determining that the respective distances exceed the second threshold distance, communicating, by the first device, a de-authentication instruction to the one or more authenticatable devices to de-authenticate the user on the one or more authenticatable devices.

3. The method according to claim 1, wherein communicating the authentication information to the one or more authenticatable devices comprises communicating the authentication information via a communication protocol that is different from a UWB communication protocol.

4. The method according to claim 1, wherein communicating the authentication information to the one or more authenticatable devices comprises communicating the authentication information to a particular authenticatable device of the one or more authenticatable devices that is closest in distance to the first device.

5. The method according to claim 4, further comprising:
determining a direction of travel of the first device, wherein communicating the authentication information to the particular authenticatable device that is closest in distance to the first device further comprises communicating the authentication information to a particular authenticatable device of the one or more authenticatable devices that is closest in distance to the first device, and that is in the direction of travel.

6. The method according to claim 5, wherein determining the direction of travel of the first device comprises determining, by the first device, a rate at which first device approaches one or more authenticatable devices.

7. The method according to claim 1, wherein communicating, by the first device, the authentication information to the one or more authenticatable devices comprises communicating authentication information configured to cause the one or more authenticatable devices to authenticate the user without generating an indication that the user is authenticated.

8. The method according to claim 1, wherein the authentication information specifies a username and a password associated with the user of the one or more authenticatable devices.

9. The method according to claim 1, wherein communicating, by the first device, authentication information to the one or more of the authenticatable devices comprises communicating, by a wearable device, authentication information to one or more personal computers to authenticate a user of the wearable device on the one or more personal computers.

10. A computing device that comprises:
one or more processors; and
a memory in communication with the one or more processors, wherein the memory stores instruction code that, when executed by the one or more processors, causes the computing device to perform operations comprising:
broadcasting, by the computing device, an ultrawideband (UWB) message;
receiving, by the computing device, one or more UWB responses to the UWB message from one or more UWB equipped devices;
determining, based on timing information associated with the UWB message and the one or more UWB responses, respective distances to the one or more UWB equipped devices;
determining one or more of the UWB equipped devices having respective distances to the computing device that are within a threshold radius of the computing device to be authenticatable devices; and
communicating, by the computing device, authentication information to one or more of the authenticatable devices to authenticate a user of the computing device on the one or more authenticatable devices.

11. The computing device according to claim 10, wherein the operations further comprise:
after authenticating the user on the one or more authenticatable devices, determining, by the computing device, that respective distances from the one or more authenticatable device exceed a second threshold distance; and
responsive to determining that the respective distances exceed the second threshold distance, communicating, by the computing device, a de-authentication instruction to the one or more authenticatable devices to de-authenticate the user on the one or more authenticatable devices.

12. The computing device according to claim 10, wherein communicating the authentication information to the one or more authenticatable devices comprises communicating the authentication information via a communication protocol that is different from a UWB communication protocol.

13. The computing device according to claim 10, wherein communicating the authentication information to the one or more authenticatable devices comprises communicating the authentication information to a particular authenticatable device of the one or more authenticatable devices that is closest in distance to the computing device.

14. The computing device according to claim 13, wherein the operations further comprise:
determining a direction of travel of the computing device, wherein communicating the authentication information to the particular authenticatable device of the plurality of authenticatable devices that is closest in distance to the computing device further comprises communicating the authentication information to a particular authenticatable device of the one or more authenticatable devices that is closest in distance to the computing device, and that is in the direction of travel.

15. The computing device according to claim 15, wherein determining the direction of travel of the computing device comprises determining a rate at which the computing device approaches one or more authenticatable devices.

16. The computing device according to claim 10, wherein communicating, by the computing device, the authentication information to the one or more authenticatable devices comprises communicating authentication information configured to cause the one or more authenticatable devices to authenticate the user without generating an indication that the user is authenticated.

17. The computing device according to claim 10, wherein the authentication information specifies a username and a password associated with the user of the one or more authenticatable devices.

18. The computing device according to claim 10, wherein the computing device corresponds to a wearable device, and the one or more authenticatable devices correspond to a personal computer.

19. A non-transitory computer-readable medium having stored thereon instruction code, wherein when executed by one or more processors of a computing device, the instruction code causes the computing device to perform operations comprising:
broadcasting, by the computing device, an ultrawideband (UWB) message;
receiving, by the computing device, one or more UWB responses to the UWB message from one or more UWB equipped devices;
determining, based on timing information associated with the UWB message and the one or more UWB responses, respective distances to the one or more UWB equipped devices;
determining one or more of the UWB equipped devices having respective distances to the computing device that are within a threshold radius of the computing device to be authenticatable devices; and
communicating, by the computing device, authentication information to one or more of the authenticatable devices to authenticate a user of the computing device on the one or more authenticatable devices.

20. The non-transitory computer-readable medium according to claim 19, wherein the operations further comprise:
after authenticating the user on the one or more authenticatable devices, determining, by the computing device that respective distances from the one or more authenticatable devices exceed a second threshold distance; and
responsive to determining that the respective distances exceed the second threshold distance, communicating, by the computing device, a de-authentication instruction to the one or more authenticatable devices to de-authenticate the user on the one or more authenticatable devices.
